(19) United States
(12) Patent Application Publication
(10) Pub. No.: US 2009/0010733 A1
(43) Pub. Date: Jan. 8, 2009

(54) COUNTERTOP CONNECTING FASTENER SECURING DEVICE

(76) Inventors: Siegfried Wecker, Schloss Holte-Stukenbrock - Liemke (DE); Boris Bredenbals, Hovelhof (DE); Andreas Kraemer, Avila Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(21) Appl. No.: 12/127,796

(22) Filed: May 27, 2008

(30) Foreign Application Priority Data
May 28, 2007 (DE) 20 2007 007 604.5
Aug. 7, 2007 (DE) 20 2007 011 190.8

(51) Int. Cl. F16B 37/04

(52) U.S. Cl. 411/172; 29/428; 29/240

(57) ABSTRACT

A countertop connecting fastener securing device, comprising: a first portion, wherein the first portion abuts a countertop section, wherein the first portion engages the countertop section to apply a force in a first direction; a second portion, wherein the second portion abuts the countertop section, wherein the second portion engages the countertop section to apply a force in a second direction, wherein the second direction is a direction that is different from the first direction; and a fastener connection, wherein the fastener connection couples the countertop connecting fastener securing device to a countertop connecting fastener.

This application claims priority under 35 U.S.C. 119 to German Patent Application No. 20 2007 011 190.8, filed Aug. 7, 2007, of Boris Bredenbals, and German Patent Application No. 20 2007 007 604.5 filed May 28, 2007, of Boris Bredenbals; both applications of which are hereby fully incorporated herein by this reference.

### BACKGROUND OF THE INVENTION

1. Field of the Invention

The present invention relates generally to a countertop installation device, and more specifically to a device that secures a countertop connecting fastener (e.g. bolt, or screw) to a pre-milled groove located underneath a countertop section, wherein the countertop connecting fastener (e.g. bolt, or screw) is used to connect two countertop sections. The present invention ensures that the smooth and seamless connection between the two countertop sections is easily accomplished.

While this application focuses on countertops, the present invention is not limited to countertops as it can be applied to countless other devices and systems that require a connecting fastener to be secured on to the device and system.

2. Discussion of the Related Art

Countertops are commonly installed onto kitchen tables and cabinets, bathroom sinks, and restaurant bars. Countertops are usually formed by connecting a plurality of smaller countertop sections to form an aesthetically pleasing and functional full sized countertop. One of the main goals of a countertop installer is to connect two or more countertop sections such that there is a level and seamless surface at the connecting points of the countertop sections. The process of connecting the plurality of countertop sections requires an installer to apply glue to the areas that the countertop sections will be joined, place a countertop connecting fastener (e.g. bolt or screw) in the pre-milled grooves located on the underside of the countertop sections, adjust the alignment of the two pieces of countertop sections such that there is a level and seamless surface, and then tighten the countertop connecting fastener to permanently join the countertop pieces.

Currently, the countertop connecting fastener connects the two pieces of countertop sections using two rectangular plates (one with a guiding hole for the countertop connecting fastener, the other with a screw thread for the connecting countertop fastener) that are placed in the pre-milled grooves of each countertop section, when the installer tightens the countertop connecting fastener with a wrench, the rectangular plates push the countertop pieces together (see FIG. 1).

However, the problem with the current approach is that the process of adjusting the alignment of the countertop sections causes the countertop connecting fastener and the rectangular plates to drop out of the pre-milled grooves. Although the installer can hold the countertop connecting fastener and the rectangular plates in place, it is a difficult task as the countertop connecting fastener and the rectangular plates are usually located in a difficult to reach place that is underneath the countertop sections.

Another problem with the current method is that the glue that is applied between the countertop sections is usually partly dried before all the adjusting of the countertop sections and the tightening of the countertop connecting fastener can be completed. This makes it difficult or nearly impossible for the countertop installer to adjust the accrued unevenness in the countertop surface. Often, the countertop installer tries to adjust the accrued unevenness with the help of a rubber hammer or a similar tool, which frequently causes damage to the countertop surface.

Yet another problem with the current method and device is that the current method and device cannot, and does not, ensure a constant parallel position between the countertop connecting fastener and the bottom surface of the pre-milled groove of the countertop section. The non-parallel position of the countertop connecting fastener, combined with the high pressure that is generated by the tightening of the countertop connecting fastener, and the not yet fully dried glue, causes the countertop sections to curl up against each other overnight, even after the countertop installer makes a seemingly smooth connection.

Thus, there is a need in the art for a device that can secure the countertop connecting fastener within the pre-milled groove of the countertop sections such that the countertop connecting fastener will not fall out of the pre-milled grooves when an installer is aligning the two countertop sections, that the tightening of the countertop connecting fastener is easily accomplished, and that the tightening of the countertop connecting fastener will not affect the alignment of the countertop sections.

### SUMMARY OF THE INVENTION

In one embodiment, the invention can be characterized as a countertop connecting fastener securing device, comprising: a first portion, wherein the first portion abuts a countertop section, wherein the first portion engages the countertop section to apply a force in a first direction; a second portion, wherein the second portion abuts the countertop section, wherein the second portion engages the countertop section to apply a force in a second direction, wherein the second direction is a direction that is different from the first direction; and a fastener connection, wherein the fastener connection couples the countertop connecting fastener securing device to a countertop connecting fastener.

In another embodiment, the invention can be characterized as a method for securing a countertop connecting fastener, comprising the steps of: coupling the countertop connecting fastener to a fastener connection of a countertop connecting fastener securing device; placing a first portion of the countertop connecting fastener securing device in a pre-milled groove of a countertop section, wherein the first portion abuts a countertop section, wherein the first portion engages the countertop section to apply a force in a first direction; and placing a second portion of the countertop connecting fastener securing device in the pre-milled groove of the countertop section, wherein the second portion abuts the countertop section, wherein the second portion engages the countertop section to apply a force in a second direction, wherein the second direction is a direction that is different from the first direction.

In yet another embodiment, the invention can be characterized as a countertop installation device, comprising: a means for securing a countertop connecting fastener in a pre-milled groove of a countertop section; and a means for preventing lateral displacement and rotational displacement of the countertop connecting fastener securing device.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a top view of the prior art, showing a countertop connecting fastener and a plurality of rectangular plates, used in countertop installations.

FIG. 2 is a top perspective view of a countertop installation device, showing a countertop connecting fastener, a screw nut, and a first countertop connecting fastener securing device, and a second countertop connecting fastener securing device.

FIG. 3 is a top view of a countertop installation device in accordance with the embodiment of FIG. 2, showing a countertop connecting fastener, a screw nut, a first countertop connecting fastener securing device, a second countertop connecting fastener securing device, a first countertop section, a second countertop section, a first T-shaped pre-milled groove, and a second T-shaped pre-milled groove.

FIG. 4 is a top view of a countertop installation device in accordance with the embodiment of FIG. 2, showing a countertop connecting fastener, a screw nut, a first countertop connecting fastener securing device, a second countertop connecting fastener securing device, a first countertop section, a second countertop section, a first T-shaped pre-milled groove, and a second T-shaped pre-milled groove. Also shown is an installer using a wrench to tighten the countertop connecting fastener such that the first countertop connecting fastener securing device engages the first countertop section to apply a force in a first direction, wherein the first direction is towards the second countertop piece.

FIG. 5 is a side perspective view of a countertop installation device in accordance with the embodiment of FIG. 2, showing a countertop connecting fastener, a screw nut, a first countertop connecting fastener securing device, and a second countertop connecting fastener securing device.

FIG. 6 is a front perspective view of a countertop installation device in accordance with the embodiment of FIG. 2, showing a countertop connecting fastener, a screw nut, a first countertop connecting fastener securing device, and a second countertop connecting fastener securing device.

FIG. 7 is a rear perspective view of a countertop installation device in accordance with the embodiment of FIG. 2, showing a countertop connecting fastener, a screw nut, a first countertop connecting fastener securing device, and a second countertop connecting fastener securing device.

FIG. 8 is a top plan view of a countertop installation device in accordance with the embodiment of FIG. 2, showing a countertop connecting fastener, a screw nut, a first countertop connecting fastener securing device, and a second countertop connecting fastener securing device.

FIG. 9 is a side view of a countertop installation device in accordance with the embodiment of FIG. 2, showing a countertop connecting fastener, a screw nut, a first countertop connecting fastener securing device, and a second countertop connecting fastener securing device.

FIG. 10 is a font view of a countertop installation device in accordance with the embodiment of FIG. 2, showing a countertop fastener securing device, and a countertop connecting fastener.

FIG. 11 is a rear view of a countertop installation device in accordance with the embodiment of FIG. 2, showing a countertop connecting fastener, a screw nut, a first countertop connecting fastener securing device, and a second countertop connecting fastener securing device.

FIG. 12 is a side perspective view of a countertop fastener securing device, showing a first portion, a second portion, and a third portion.

FIG. 13 is a front perspective view of a countertop fastener securing device in accordance with the embodiment of FIG. 12, showing a first portion, an fastener connection, a second portion, and a third portion.

FIG. 14 is a rear perspective view of a countertop fastener securing device in accordance with the embodiment of FIG. 12, showing a main body, an fastener connection, a second portion, and a third portion.

FIG. 15 is a top perspective view of an alternative embodiment of the countertop installation device of FIG. 2, showing a countertop connecting fastener, a screw nut, a first countertop connecting fastener securing device, and a second countertop connecting fastener securing device.

FIG. 16 is a front perspective view of a countertop installation device in accordance with the embodiment of FIG. 15, showing a countertop connecting fastener, a screw nut, a first countertop connecting fastener securing device, and a second countertop connecting fastener securing device.

FIG. 17 is a front view of a countertop installation device in accordance with the embodiment of FIG. 15, showing a countertop connecting fastener securing device, and a countertop connecting fastener.

FIG. 18 is a side view of a countertop installation device in accordance with the embodiment of FIG. 15, showing a countertop connecting fastener, a screw nut, a first countertop connecting fastener securing device, and a second countertop connecting fastener securing device.

FIG. 19 is a rear view of a countertop installation device in accordance with the embodiment of FIG. 15, showing a countertop connecting fastener securing device, a countertop connecting fastener, and a screw nut.

FIG. 20 is a side perspective view of an alternative embodiment of the countertop connecting fastener securing device of FIG. 12, showing a first portion, a second portion, and a third portion.

FIG. 21 is a top plan view of a countertop connecting fastener securing device in accordance with the embodiment of FIG. 20, showing a first portion, a second portion, and a third portion.

FIG. 22 is a side view of a countertop connecting fastener securing device in accordance with the embodiment of FIG. 20, showing a first portion, and a third portion.

FIG. 23 is a rear view of a countertop connecting fastener securing device in accordance with the embodiment of FIG. 20, showing a first portion, a second portion, and a third portion, and a square shaped fastener connection.

FIG. 24 is a plurality of views of a countertop connecting fastener securing device in accordance with the embodiment of FIG. 2, showing preferred measurements in a scale of 5:1.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Countertops, such as a kitchen countertop, are usually formed by installing or joining a plurality of countertop sections to form the finished countertop. Countertop installation usually requires that a countertop installer to first apply an adhesive, such as wood glue, to areas that the countertop sections are to be joined, second to use some type of countertop connecting fastener, such as a bolt or a screw, to pull the countertop sections together, third, before the glue dries, make any adjustments on the alignment of the countertop sections, and finally to tighten the countertop connecting fastener, such as a bolt or a screw, to a point that the countertop sections are permanently joined.

The countertop sections are usually made of wood, such as plywood or particle board, and can be laminated or surfaced treated with materials such as FORMICA or CORIAN. Countertop sections can also be made of stone, such as marble or granite. To facilitate countertop installers' use of a countertop connecting fastener to join the countertop sections, manufacturers of the countertop sections form pre-milled grooves on at least one of the sides of the countertop sections. These pre-milled grooves are usually T-shaped, Y-shaped, or mushroom shaped to allow a countertop connecting fastener, such as a bolt or a screw, along with a countertop connecting fastener securing device, to pull a horizontally oriented countertop section toward another countertop section.

A challenge that most countertop installers have is to be able to secure the countertop connecting fastener in the pre-milled groove while adjusting the alignment of the countertop sections. Since the pre-milled groove and the countertop connecting fastener are located in a hard to reach area underneath the countertop sections, the installer does not have the ability to simultaneously hold the countertop connecting fastener in place while aligning the countertop sections. Another challenge for the countertop installer is that when tightening the countertop connecting fastener, the countertop connecting fastener is located deep within the groove and thus making it hard to reach with a wrench. Yet another challenge for the countertop installer is that the final tightening of the countertop connecting fastener usually causes the alignment of the countertop sections to unfavorably change. Yet another challenge is that the current methods and devices cannot, and do not, ensure a constant parallel position between the countertop connecting fastener and the bottom surface of the pre-milled groove of the countertop section. The non-parallel position of the countertop connecting fastener, combined with the high pressure that is generated by the tightening of the countertop connecting fastener, and the not yet fully dried glue, causes the countertop sections to curl up against each other, even after the countertop installer makes a seemingly smooth connection.

Thus there is a need in the art for a device that is able to secure the countertop connecting fastener (e.g. bolt or screw) in the pre-milled groove while the countertop installer adjusts the alignment of the countertop sections, that is able to provide easier access to the countertop connecting fastener, that is able to not affect the alignment of countertop sections when the installer tightens the countertop connecting fastener to permanently join the countertop sections, and that is able to maintain a constant parallel position between the countertop connecting fastener and the bottom surface of the pre-milled groove of the countertop section.

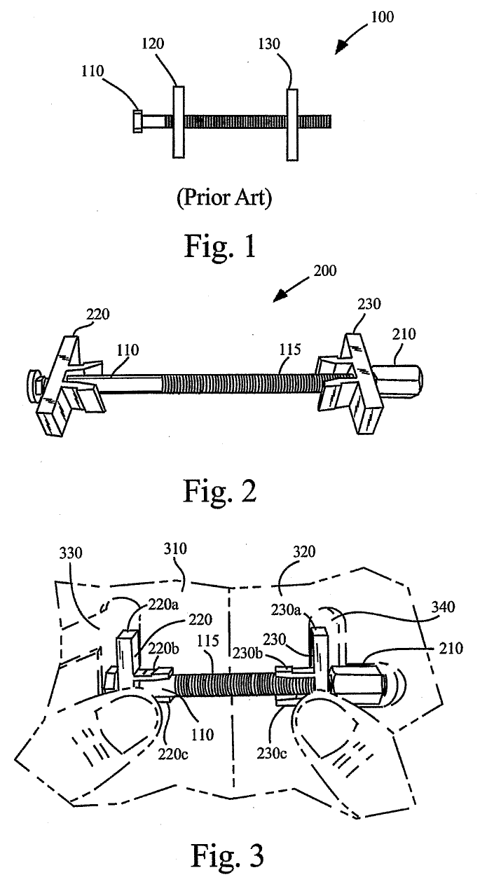

Referring to FIG. 1 is a top view of the prior art currently used in countertop installations, showing a countertop connecting fastener 110, a first rectangular plate 120, and a second rectangular plate 130. The countertop connecting fastener 110 is placed through a guiding hole (not shown) of the first rectangular plate 120 and a threaded screw hole (not shown) of the second rectangular plate 130. The countertop connecting fastener 110, the first rectangular plate 120, and the second rectangular plate 130 are then placed in a pre-milled groove of two countertop sections (not shown). Eventually the countertop installer tightens the countertop connecting fastener 110 such that the first rectangular plate 120 and the second rectangular plate 130 push the two countertop sections together.

However, the placement of the countertop connecting fastener 110 in a pre-milled groove (not shown) is not very secure, as the countertop connecting fastener 110 and the first rectangular plate 120 and the second rectangular plate 130 usually falls out of the pre-milled groove before the countertop installer is able to tighten the countertop connecting fastener 110. In addition, even if the countertop connecting fastener 110 did not fall out, and the countertop installer is able to tighten the countertop connecting fastener 110, the tightening process of the current countertop installation device 100 usually causes the alignment of the countertop sections to shift from an optimal position.

Referring to FIG. 2, a top perspective view of a countertop installation device (200) in accordance with one embodiment of the present invention, showing a countertop connecting fastener 110, a screw nut 210, a first countertop connecting fastener securing device 220, and a second countertop connecting fastener securing device 230. The countertop connecting fastener 110 is coupled to a fastener connection, e.g., an aperture (not shown), of the first countertop connecting fastener securing device 220 and the fastener connection, e.g., an aperture (not shown), of the second countertop connecting fastener securing device 230. A screw nut 210 is then coupled to a second end, i.e., a threaded end 115, of the countertop connecting fastener 110.

While the fastener connection can be an aperture, the fastener connection can couple the countertop connecting fastener to the countertop connecting fastener securing device via other methods, for example, a fitted groove, a bonding agent, or a magnet.

While this figure shows a bolt as the countertop connecting fastener 110, the countertop installation device can utilize a variety of available fasteners, such as a screw or a nail (not shown).

The first countertop connecting fastener securing device 220 and the second countertop connecting fastener securing device 230 can be of plastic, metal, or composite material. However, plastic is the preferred material as it is more flexible and of lower cost to produce.

Referring to FIG. 3, a top view of a countertop installation device in accordance with the embodiment of FIG. 2, showing a countertop connecting fastener 110, a screw nut 210, a first countertop connecting fastener securing device 220, a second countertop connecting fastener securing device 230, a first countertop section 310, a second countertop section 320, a first T-shaped pre-milled groove 330, and a second T-shaped pre-milled groove 340.

The fastener connection, e.g., an aperture (not shown), of the first countertop connecting fastener securing device 220, couples the countertop connecting fastener 110 to the first countertop connecting fastener securing device 220. The fastener connection, e.g., an aperture (not shown), of the second countertop connecting fastener securing device 230, couples the countertop connecting fastener 110 to the second countertop connecting fastener securing device 230. A screw nut 210 is then coupled to a second end (i.e. a threaded end) 115 of the countertop connecting fastener 110.

While the fastener connection can be an aperture, the fastener connection can couple the countertop connecting fastener to the countertop connecting fastener securing device via other methods, for example, a fitted groove, a bonding agent, or a magnet.

While this figure shows a bolt as the countertop connecting fastener 110, the countertop installation device can utilize a variety of available fasteners, such as a screw or a nail (not shown) for the countertop connecting fastener 110.

Also shown are the first countertop connecting fastener securing device 220 and the second countertop connecting fastener securing device 230 securing the countertop connecting fastener 110 and the screw nut 210 in the first T-shaped pre-milled groove 330 of the first countertop section 310 and the second T-shaped pre-milled groove 340 of the second countertop section 320.

The first countertop connecting fastener securing device 220 secures the fastener 110 to the first countertop section 310 by having a first portion 220A of the first countertop connecting fastener securing device 220 abut the first countertop section 310 and engage the first countertop section 310 to apply a force in a first direction, by having a second portion 220B of the first countertop connecting fastener securing device 220 abut the first countertop section 310 and engage the first countertop section 310 to apply a force in a second direction, and by having a third portion 220C of the first countertop connecting fastener securing device 220 abut the first countertop section 310 and engage the countertop section to apply a force in a third direction.

The second direction is a direction that is different from the first direction, and as shown here, it is perpendicular to the first direction. The third direction is a direction that is different from the first and second and directions, and as shown here, it is also perpendicular to the first direction. However, while this figure shows the first countertop connecting fastener securing device 220 applying force in three directions, an alternative embodiment may have the first countertop connecting fastener securing device 220 applying a force in only the first direction and a second direction. Also, in the alternative embodiment the second direction can be a direction that is not perpendicular to the first direction.

Also as shown in FIG. 3, the a first portion 220A of the first countertop fastener securing device 220, the second portion 220B of the first countertop fastener securing device 220, and the third portion 220C of the first countertop fastener securing device 220 engage the first countertop section 310 by friction, however alternative embodiments of the first countertop fastener securing device 220 may engage the first countertop section 310, for example, via pressure, spring force, magnetic fields, and interlocking teeth and grooves.

The second countertop connecting fastener securing device 230 secures the fastener 110 to the second countertop section 320 by having a first portion 230A of the second countertop connecting fastener securing device 230 abut the second countertop section 320 and engage the second countertop section 320 to apply a force in a fourth direction, by having a second portion 230B of the second countertop connecting fastener securing device 230 abut the second countertop section 320 and engage the second countertop section 320 to apply a force in the second direction, and having a third portion 220C of the second countertop connecting fastener securing device 220 abut the second countertop section 310 and engage the countertop section to apply a force in the third direction.

The fourth direction is a direction opposite to the first direction, the second direction is a direction that is different from the fourth direction, and as shown here is perpendicular to the fourth direction. The third direction is a direction that is different from the fourth and second and directions, and as shown here is also perpendicular to the fourth direction.

However, while this figure shows the second countertop connecting fastener securing device 230 applying force in three directions, an alternative embodiment may have the second countertop connecting fastener securing device 230 apply a force in only the fourth direction and the second direction. Also, in the alternative embodiment the second direction can be a direction that is not perpendicular to the fourth direction.

As shown in FIG. 3, the first portion 230A of the second countertop fastener securing device 230, the second portion 230B of the second countertop fastener securing device 230, and the third portion 230C of the second countertop fastener securing device 230 engage the second countertop section 320 by friction, however alternative embodiments of the second countertop fastener securing device 230 may engage the second countertop section 320, for example, via pressure, spring force, magnetic fields, and interlocking teeth and grooves.

Upon tightening of the countertop connecting fastener 110, a first portion 220A of the first countertop fastener securing device 220 engages the first countertop section 310 and applies a force to the first countertop section 310 in a first direction (i.e. the direction towards the second countertop section 320) such that the first countertop section 310 and the second countertop section 320 will permanently join without causing rotational displacement or lateral displacement to the connecting fastener 110.

The height the first countertop connecting fastener securing device 220 and the second countertop connecting fastener securing device 230 should be close to depth of the first T-shaped pre-milled groove 330 of the first countertop section 310 and the second T-shaped pre-milled groove 340 of the second countertop section 320. The range of permissible heights of the first countertop connecting fastener securing device 220 and the second countertop connecting fastener securing device 230 can vary with the range of the depths of the pre-milled grooves. Preferably, the height the first countertop connecting fastener securing device 220 and the second countertop connecting fastener securing device 230 is slightly higher than the first T-shaped pre-milled groove 330 of the first countertop section 310 and the second T-shaped pre-milled groove 340 of the second countertop section 320, thereby providing more leverage against the first countertop section 310 and the second countertop section 320, and providing easier access to the countertop connecting fastener 110 for tightening by the countertop installer.

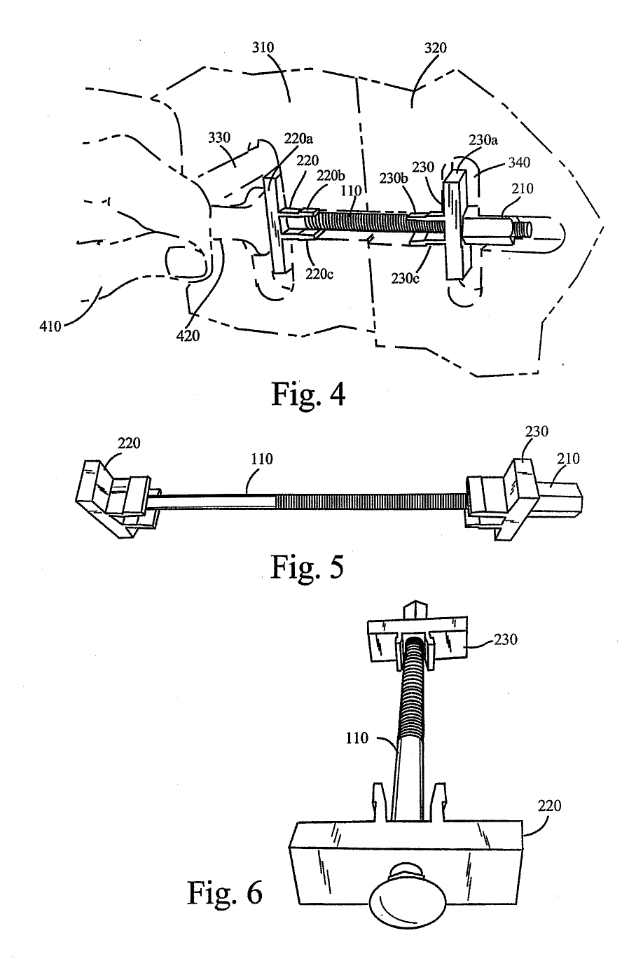

Referring to FIG. 4, a top view of a countertop installation device in accordance with the embodiment of FIG. 2, showing a countertop connecting fastener 110, a screw nut 210, a first countertop connecting fastener securing device 220, a second countertop connecting fastener securing device 230, a first countertop section 310, a second countertop section 320, a first T-shaped pre-milled groove 330, and a second T-shaped pre-milled groove 340.

Also shown is an installer 410 using a wrench 420 to tighten the countertop connecting fastener 110 such that the first portion 220A of the first countertop connecting fastener securing device 220 engages the first countertop section 310 to apply a force in a first direction, wherein the first direction is a direction towards the second countertop piece 320.

The first countertop connecting fastener securing device 220 comprising the first portion 220A, a second portion 220B, and a third portion 220C. As shown, the first portion 220A, the second portion 220B, and the third portion 220C abut the first countertop section 310. The first portion 220A engages the first countertop section 310 via friction. The second portion 220B and the third portion 220C engage the first countertop section 310 also via friction (i.e. by being positioned at a distance from each other such that the second portion 220B and the third portion 220C fit tightly within the first T-shaped pre-milled groove 330 of the first countertop section 310). Preferably the second portion 220B and the third portion 220C are of flexible material and are at a distance from each other that is slightly wider than the width of the first T-shaped pre-milled groove 330 of the first countertop section 310, thereby providing more of a resistance (i.e. grip) against the first countertop section 310.

The second countertop connecting fastener securing device 230 comprising a first portion 230A, a second portion 230B, and a third portion 230C. As shown, the first portion 230A, the second portion 230B, and the third portion 230C abut the second countertop section 320. The first portion 230A engages the second countertop section 320 via friction. The second portion 230B and the third portion 230C engage the second countertop section 320 also via friction (i.e. by being positioned at a distance from each other such that the second portion 230B and the third portion 230C fit tightly within the first T-shaped pre-milled groove 340 of the second countertop section 320). Preferably the second portion 230B and the third portion 230C are of flexible material and are at a distance from each other that is slightly wider than the width of the second T-shaped pre-milled groove 340 of the second countertop section 320, thereby providing more of a resistance (i.e. grip) against the second countertop section 320.

The second direction is a direction that is different from the first direction, and as shown here is perpendicular to the first direction. The third direction is a direction that is different from the first and second and directions, and as shown here is also perpendicular to the first direction. However, while this figure shows the first countertop connecting fastener securing devices 220, 230 applying force in three directions, an alternative embodiment may have the first countertop connecting fastener securing device 220 applying a force in only the first direction and the second direction, and the second countertop connecting fastener securing device 230 applying a force in only the fourth direction and the second direction. Also, in the alternative embodiment the second direction can be a direction that is not perpendicular to the first direction.

The fourth direction is a direction opposite to the first direction, the second direction is a direction that is different from the fourth direction, and as shown here is perpendicular to the fourth direction.

Also preferably, the second portions 220B, 230B and the third portions 220C, 230C comprise jagged edges, e.g., teeth-like structures (not shown) on the sides such that the second portions 220B, 230B and the third portions 220C, 230C engage the countertop sections 310, 320 with a better grip on the countertop sections 310, 320. In the embodiment of FIG. 2, the second portions 220B, 230B and the third portions 220C, 230C are positioned parallel to each other and perpendicular to the first portions 220A, 230A. However, variations of this structure can be implemented with a goal of maintaining the position of the first portions 220A, 230A within the pre-milled grooves 330, 340 of the countertop sections 310, 320, a goal of preventing lateral displacement and rotational displacement of the first portions 220A, 220B, and a goal that the first portions 220A, 230A are configured to apply a force to the countertop sections 310, 320 in a first direction and a fourth direction (i.e. toward each other), when the countertop connecting fastener 110 is tightened.

Referring to FIG. 5, a side perspective view of a countertop installation device in accordance with the embodiment of FIG. 2, is shown of a countertop connecting fastener 110, a screw nut 210, a first countertop connecting fastener securing device 220, and a second countertop connecting fastener securing device 230.

These structures are described above in reference to FIGS. 2-4.

Referring to FIG. 6, a front perspective view of a countertop installation device in accordance with the embodiment of FIG. 2, is shown of a countertop connecting fastener 110, a screw nut 210, a first countertop connecting fastener securing device 220, and a second countertop connecting fastener securing device 230.

These structures are described above in reference to FIGS. 2-4.

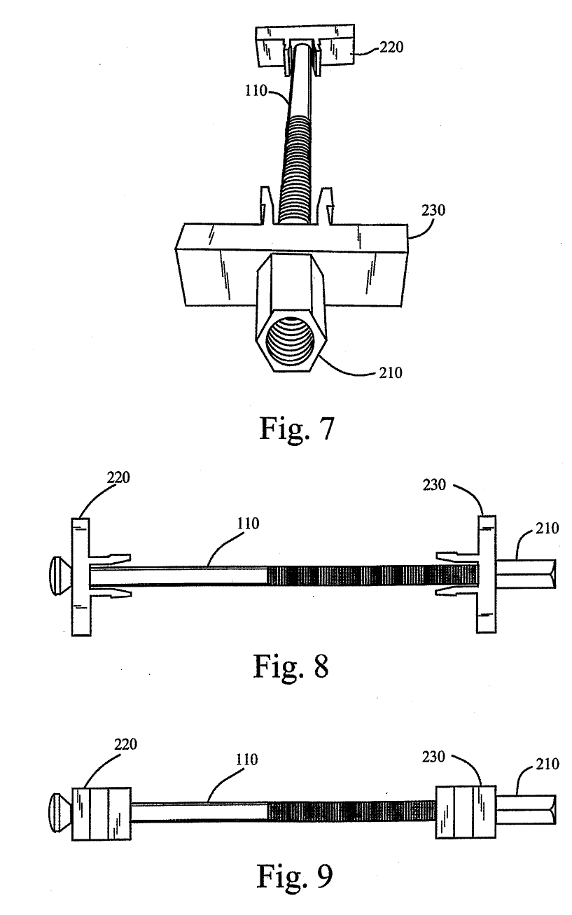

Referring to FIG. 7, a rear perspective view of a countertop installation device in accordance with the embodiment of FIG. 2, is shown of a countertop connecting fastener 110, a screw nut 210, a first countertop connecting fastener securing device 220, and a second countertop connecting fastener securing device 230.

These structures are described above in reference to FIGS. 2-4.

Referring to FIG. 8, a top plan view of a countertop installation device in accordance with the embodiment of FIG. 2, is shown of a countertop connecting fastener 110, a screw nut 210, a first countertop connecting fastener securing device 220, and a second countertop connecting fastener securing device 230.

These structures are described above in reference to FIGS. 2-4.

Referring to FIG. 9, a side view of a countertop installation device in accordance with the embodiment of FIG. 2, is shown of a countertop connecting fastener 110, a screw nut 210, a first countertop connecting fastener securing device 220, and a second countertop connecting fastener securing device 230.

These structures are described above in reference to FIGS. 2-4.

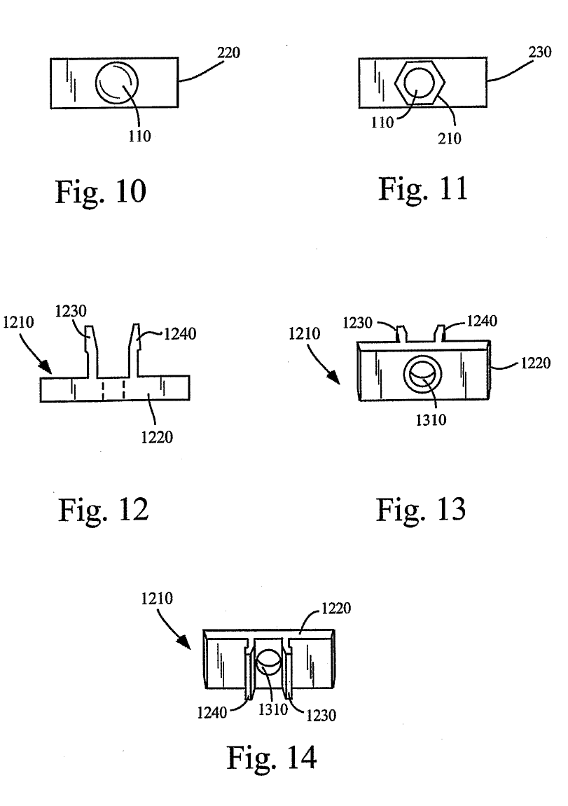

Referring to FIG. 10, a front view of a countertop installation device in accordance with the embodiment of FIG. 2, is shown of a countertop connecting fastener 110, and a first countertop connecting fastener securing device 220.

These structures are described above in reference to FIGS. 2-4.

Referring to FIG. 11, a rear view of a countertop installation device in accordance with the embodiment of FIG. 2, is shown of a countertop connecting fastener 110, a screw nut 210, a first countertop connecting fastener securing device 220, and a second countertop connecting fastener securing device 230.

These structures are described above in reference to FIGS. 2-4.

Referring to FIG. 12, a side perspective view of a countertop fastener securing device 1210, showing a first portion 1220, a second portion 1230, and a third portion 1240.

These structures are described above in reference to FIGS. 2-4.

Referring to FIG. 13, a front perspective view of a countertop fastener securing device 1210 in accordance with the embodiment of FIG. 12, showing a first portion 1220, an fastener connection 1310, a second portion 1230, and a third portion 1240.

These structures are described above in reference to FIGS. 2-4.

Referring to FIG. 14, a rear perspective view of a countertop fastener securing device 1210 in accordance with the embodiment of FIG. 12, showing a first portion 1220, a fastener connection 1310, a second portion 1230, and a third portion 1240.

These structures are described above in reference to FIGS. 2-4.

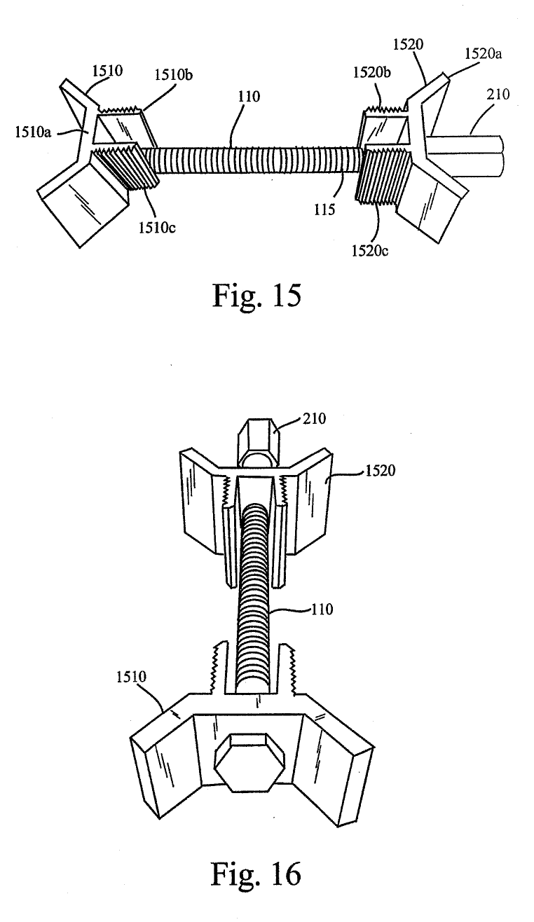

Referring to FIG. 15, a top perspective view of an alternative embodiment of the countertop installation device of FIG. 2, showing a countertop connecting fastener 110, a screw nut 210, a first countertop connecting fastener securing device 1510, and a second countertop connecting fastener securing device 1520.

The countertop connecting fastener 110 is placed through a first fastener connection (not shown) of the first countertop connecting fastener securing device 1510 and a second fastener connection (not shown) of the second countertop connecting fastener securing device 1520. A screw nut 210 is then coupled to a threaded end of the countertop connecting fastener 115. While this figure shows a countertop connecting fastener 110 as the chosen fastener, the countertop installation device can utilize a variety of available fasteners, such as a screw or a nail (not shown).

The first countertop connecting fastener securing device 1510 comprising a first portion 1510A, a second portion 1510B, and a third portion 1510C. The second portion 1510B and the third portion 1510C are positioned at a distance from each other such that the second portion 1510B and the third portion 1510C engages the first countertop section (not shown) by fitting tightly within a first Y-shaped pre-milled groove (not shown) of a first countertop section (not shown). Preferably the second portion 1510B and the third portion 1510C are of flexible material and are at a distance from each other that is slightly wider than the width of the first Y-shaped pre-milled groove of the first countertop section, thereby providing more of a resistance (i.e. grip) against the first countertop section.

The second countertop connecting fastener securing device 1520 comprising a first portion 1520A, a second portion 1520B, and a third portion 1520C. The second portion 1520B and the third portion 1520C are positioned at a distance from each other such that the second portion 1520B and the third portion 1520C engages the second countertop section (not shown) by fitting tightly within a second Y-shaped pre-milled groove (not shown) of a second countertop section (not shown). Preferably the second portion 1520B and the third portion 1520C are of flexible material and are at a distance from each other that is slightly wider than the width of the second Y-shaped pre-milled groove of the second countertop section, thereby providing more of a resistance (i.e. grip) against the second countertop section.

Also preferably and as shown, the second portions 1510B, 1520B and the third portions 1510C, 1520C comprise jagged edges, e.g., teeth-like structures, on the sides that the second portions 1510B, 1520B and the third portions 1510C, 1520C meet the countertop sections (not shown) for a better grip on the countertop sections. In the embodiment of FIG. 2, the second portions 1510B, 1520B and the third portions 1510C, 1520C are positioned parallel to each other and perpendicular to the first portions 1510A, 1520A. However, variations of this structure can be implemented with a goal of maintaining the position of the first portions 1510A, 1520A within the pre-milled grooves 330, 340 of the countertop sections, a goal of preventing lateral displacement and rotation of the first portions 1510A, 220B, and a goal that the first portions 1510A, 1520A are configured to push the countertop sections toward each other when the countertop connecting fastener 110 is tightened.

Referring to FIG. 16, a front perspective view of an embodiment of the countertop installation device of FIG. 15, is shown of a countertop connecting fastener 110, a screw nut 210, a first countertop connecting fastener securing device 1510, and a second countertop connecting fastener securing device 1520.

These structures are described above in reference to FIG. 15.

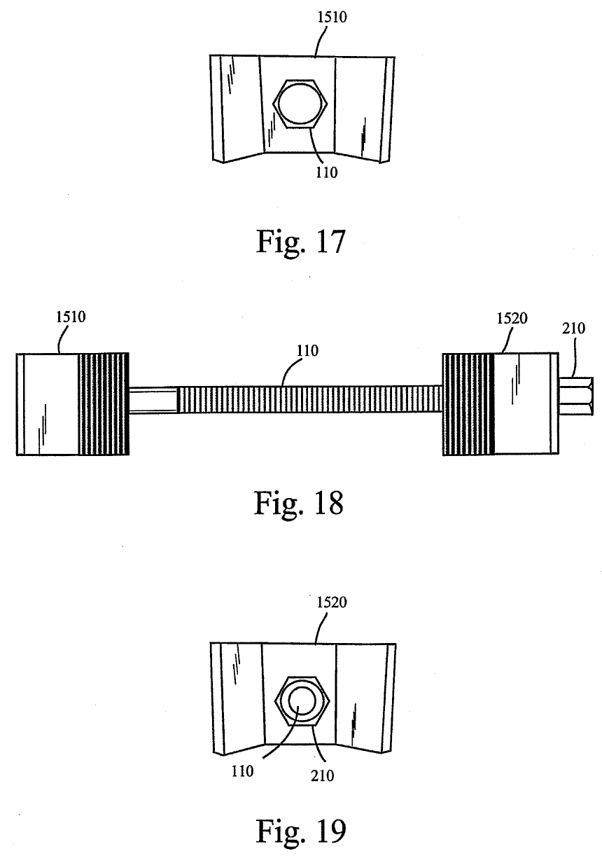

Referring to FIG. 17, a front view of a countertop installation device in accordance with the embodiment of FIG. 15, is shown of a countertop connecting fastener securing device 1510, and a countertop connecting fastener 110.

These structures are described above in reference to FIG. 15.

Referring to FIG. 18, a side view of an embodiment of the countertop installation device of FIG. 15, is shown of a countertop connecting fastener 110, a screw nut 210, a first countertop connecting fastener securing device 1510, and a second countertop connecting fastener securing device 1520.

Referring to FIG. 19, a rear view of a countertop installation device in accordance with the embodiment of FIG. 15, is shown of a countertop connecting fastener securing device 1520, and a countertop connecting fastener 110.

These structures are described above in reference to FIG. 15.

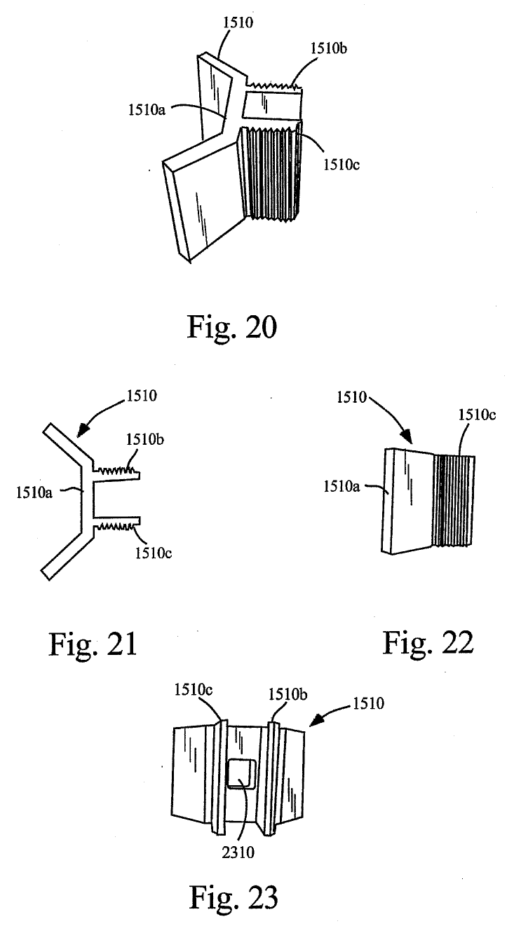

Referring to FIG. 20, a side perspective view of an alternative embodiment of the countertop connecting fastener securing device of FIG. 12, is shown of a countertop connecting fastener securing device 1510, a first portion 1510A, a second portion 1510B, and a third portion 1510C.

These structures are described above in reference to FIG. 15.

Referring FIG. 21 is a top plan view of a countertop connecting fastener securing device in accordance with the embodiment of FIG. 20, showing a countertop connecting fastener securing device 1510, a first portion 1510A, a second portion 1510B, and a third portion 1510C.

These structures are described above in reference to FIG. 15.

Referring FIG. 22 is a side view of a countertop connecting fastener securing device in accordance with the embodiment of FIG. 20, showing a countertop connecting fastener securing device 1510, a first portion 1510A, and a third portion 1510C.

These structures are described above in reference to FIG. 15.

Referring FIG. 23 is a rear view of a countertop connecting fastener securing device in accordance with the embodiment of FIG. 20, showing a countertop connecting fastener securing device 1510, a first portion 1510A, a second portion 1510B, a third portion 1510C, and a fastener connection 2310 that is a square shaped aperture.

These structures are described above in reference to FIG. 15.

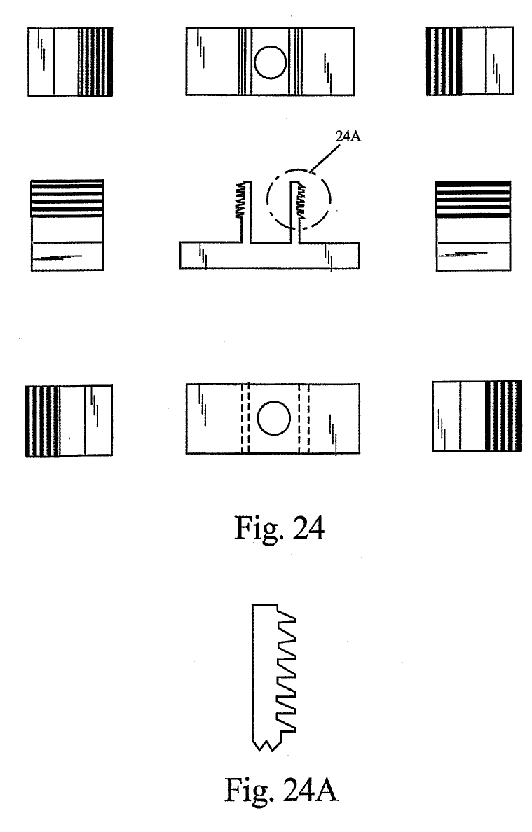

FIG. 24 is a plurality of views of a countertop connecting fastener securing device in accordance with the embodiment of FIG. 2, showing preferred measurements in a scale of 5:1.

What is claimed is:

1. A countertop connecting fastener securing device, comprising:
a first portion, wherein the first portion abuts a countertop section, wherein the first portion engages the countertop section to apply a force in a first direction;
a second portion, wherein the second portion abuts the countertop section, wherein the second portion engages the countertop section to apply a force in a second direction, wherein the second direction is a direction that is different from the first direction; and
a fastener connection, wherein the fastener connection couples the countertop connecting fastener securing device to a countertop connecting fastener.

2. The countertop connecting fastener securing device of claim 1, further comprising:
wherein the first direction is a direction towards a second countertop section.

3. The countertop connecting fastener securing device of claim 1, further comprising:
wherein the second direction is a direction perpendicular to the first direction.

4. The countertop connecting fastener securing device of claim 1, further comprising:
wherein the second portion is perpendicular to the first portion.

5. The countertop connecting fastener securing device of claim 1, further comprising:
wherein the second direction is a direction that prevents rotational displacement of the countertop connecting fastener securing device.

6. The countertop connecting fastener securing device of claim 1, further comprising:
wherein the second direction is a direction that prevents lateral displacement of the countertop connecting fastener securing device.

7. The countertop connecting fastener securing device of claim 1, further comprising:
a third portion, wherein the third portion abuts the countertop section, wherein the third portion engages the countertop section to apply a force in a third direction, wherein the third direction is a direction that is different from the first direction and the second direction.

8. The countertop connecting fastener securing device of claim 1:
wherein the countertop connecting fastener is a bolt.

9. A method for securing a countertop connecting fastener, comprising the steps of:
coupling the countertop connecting fastener to a fastener connection of a countertop connecting fastener securing device;
placing a first portion of the countertop connecting fastener securing device in a pre-milled groove of a countertop section, wherein the first portion abuts the countertop section, wherein the first portion engages the countertop section to apply a force in a first direction;
placing a second portion of the countertop connecting fastener securing device in the pre-milled groove of the countertop section, wherein the second portion abuts the countertop section, wherein the second portion engages the countertop section to apply a force in a second direction, wherein the second direction is a direction that is different from the first direction.

10. The method of claim 9, further comprising:
wherein the first direction is a direction towards a second countertop section.

11. The method of claim 9, further comprising:
wherein the second direction is a direction perpendicular to the first direction.

12. The method of claim 9, further comprising:
wherein the second portion is perpendicular to the first portion.

13. The method of claim 9, further comprising:
wherein the second direction is a direction that prevents rotational displacement of the countertop connecting fastener securing device.

14. The method of claim 9, further comprising:
wherein the second direction is a direction that prevents lateral displacement of the countertop connecting fastener securing device.

15. The method of claim 9, further comprising:
placing a third portion of the countertop connecting fastener securing device in the pre-milled groove of the countertop section, wherein the third portion abuts the countertop section, wherein the third portion engages the countertop section to apply a force in a third direction, wherein the third direction is a direction that is different from the first direction and the second direction.

16. The method of claim 9, further comprising:
wherein the countertop connecting fastener is a bolt.

17. A countertop installation device, comprising:
a means for securing a countertop connecting fastener in a pre-milled groove of a countertop section; and
a means for preventing lateral displacement and rotational displacement of the countertop connecting fastener securing device.
